(19) United States
(12) Patent Application Publication
(10) Pub. No.: US 2012/0137695 A1
(43) Pub. Date: Jun. 7, 2012

(54) FUEL NOZZLE WITH GAS ONLY INSERT

(75) Inventors: Eugene Delano White, Greenville, SC (US); Charles Steber, Atlanta, GA (US); Jean-Marc Carre, Atlanta, GA (US); Jason Tuma, Greenville, SC (US); Sean Timberlake, Palm Beach Gardens, FL (US)

(73) Assignee: GENERAL ELECTRIC COMPANY, Schnectady, NY (US)

(21) Appl. No.: 12/957,482

(22) Filed: Dec. 1, 2010

(51) Int. Cl. F02C 7/22

(52) U.S. Cl. 60/740

(57) ABSTRACT

The present application provides a fuel nozzle. The fuel nozzle may include a tube and a gas only insert tip positioned on the tube. The gas only insert tip may include a tip aperture. A plug may be positioned within the tip aperture.

### TECHNICAL FIELD

The present application relates generally to gas turbine engines and more particularly relates to an improved tip design for a gas only insert for use with a fuel nozzle so as to minimize hot gas ingestion and the like and the damage that may be caused thereby.

### BACKGROUND OF THE INVENTION

Gas turbines for power generation are generally available with fuel nozzles configured for either “dual fuel” or “gas only” operation. The “gas only” configuration refers to burning, for example, only natural gas. The “dual fuel” operation refers to having the capability of burning either natural gas or a liquid fuel. The “dual fuel” configuration generally is applied in situations where oil is used as a backup fuel in the event that natural gas is unavailable. The “gas only” configuration is offered to reduce costs because the nozzle parts and the associated equipment used for liquid fuel operations are not required. In general, fuel nozzles are designed to have “dual fuel” capabilities. The “gas only” version is a modification of the dual fuel design in which the liquid fuel parts (e.g., oil, atomizing air, and water passages and the like) are removed from the nozzle and replaced with a component of a similar size and shape, but without the internal features of the liquid fuel cartridge. This replacement component generally is known as a “gas only insert.” Other configurations and other components also may be used.

Known gas only inserts, however, have experienced overheating while the tubes leading to the gas only insert tips have experienced bulging and other types of deformation. This overheating and deformation may be due to hot gas ingestion into the gas only insert tip. Specifically, conditions may exist that allow for the transfer of heat back into the gas only insert tip and the accompanying tube. High tip and tube temperatures may be more prevalent during high combustion dynamics in certain fueling modes and/or during fuel transfers. Such overheating and deformation may require premature replacement of the overall nozzle and the added expense and downtime associated therewith.

There is thus a desire for an improved design of a gas only insert tip and an overall “gas only” fuel nozzle design. Such a gas only insert tip and fuel nozzle design should be substantially resistant to overheating and deformation caused by hot gas ingestion and the like. Moreover, such a gas only insert tip and fuel nozzle design should provide consistent performance with a long lifetime.

### SUMMARY OF THE INVENTION

The present application thus provides a fuel nozzle. The fuel nozzle may include a tube and a gas only insert tip positioned on the tube. The gas only insert tip may include a tip aperture. A plug may be positioned within the tip aperture.

The present application further provides a gas only insert for use with a fuel nozzle. The filet nozzle may include a tube and a tip positioned on the tube. The tip may include a tip end and a breather hole positioned with the tip end. The breather hole may include a diameter sufficiently large to allow an internal the tube to breath without allowing hot gas ingestion therethrough.

The present application further provides a combustor. The combustor may include a number of fuel nozzles. One or more of the fuel nozzles may include a tube and a gas only insert tip. The gas only insert tip may include a tip end with a breather hole therein.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known gas turbine engine that may be used herein.

FIG. 2 is a perspective view of a known fuel nozzle with a gas only insert therein.

FIG. 3 is a side plan view of a known gas only insert tip and tube.

FIG. 4 is a side cross-sectional view of a known gas only insert tip and tube.

FIG. 5 is a side plan view of a gas only insert tip as may be described herein.

FIG. 6 is a front plan view of the gas only insert tip of FIG. 5.

FIG. 7 is a side cross-sectional view of the gas only insert tip as shown in FIG. 5 positioned on a tube.

FIG. 8 is a side cross-sectional view of an alternative embodiment of a gas only insert tip as may be described herein.

### DETAILED DESCRIPTION

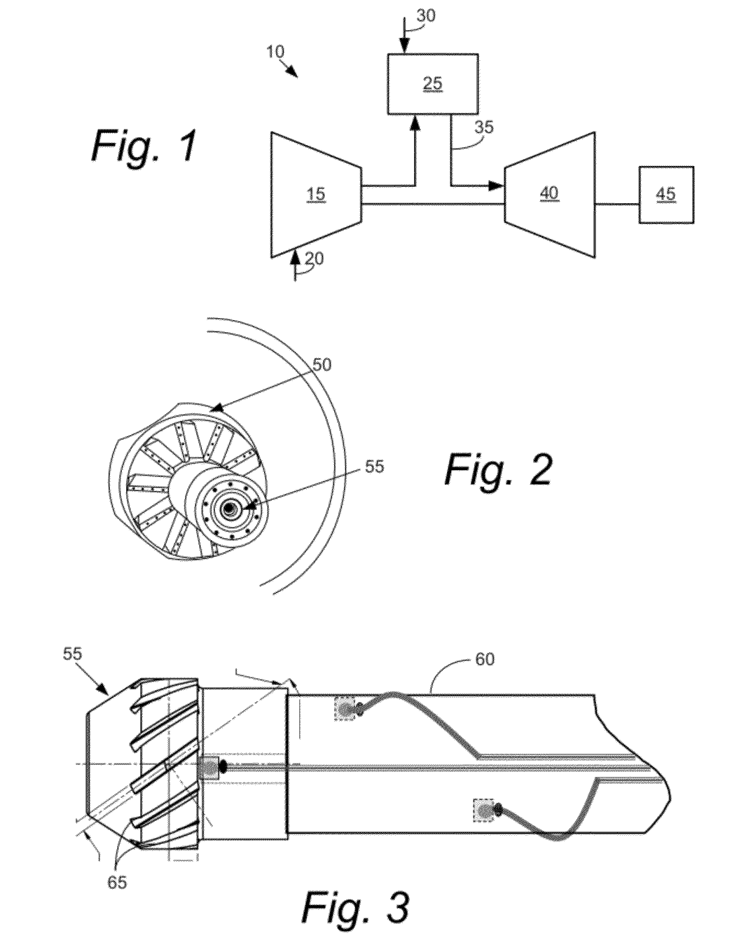

Referring now to the drawings, in which like numerals refer to like elements throughout the several views, FIG. 1 is a schematic view of a gas turbine engine 10 as may be described herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is delivered in turn to a turbine 40. The flow of combustion gases 35 drives the turbine 40 so as to produce mechanical work. The mechanical work produced in the turbine 40 drives the compressor 15 and an external load 45 such as an electrical generator and the like.

The gas turbine engine 10 may use natural gas, various types of syngas, and/or other types of fuels. The gas turbine engine 10 may be one of any number of different gas turbine engines offered by General Electric Company of Schenectady, N.Y. such as a heavy duty 9FA gas turbine engine and the like, The gas turbine engine 10 may have other configurations and may use other types of components. Other types of gas turbine engines also may be used herein. Multiple gas turbine engines 10, other types of turbines, and other types of power generation equipment also may be used herein together.

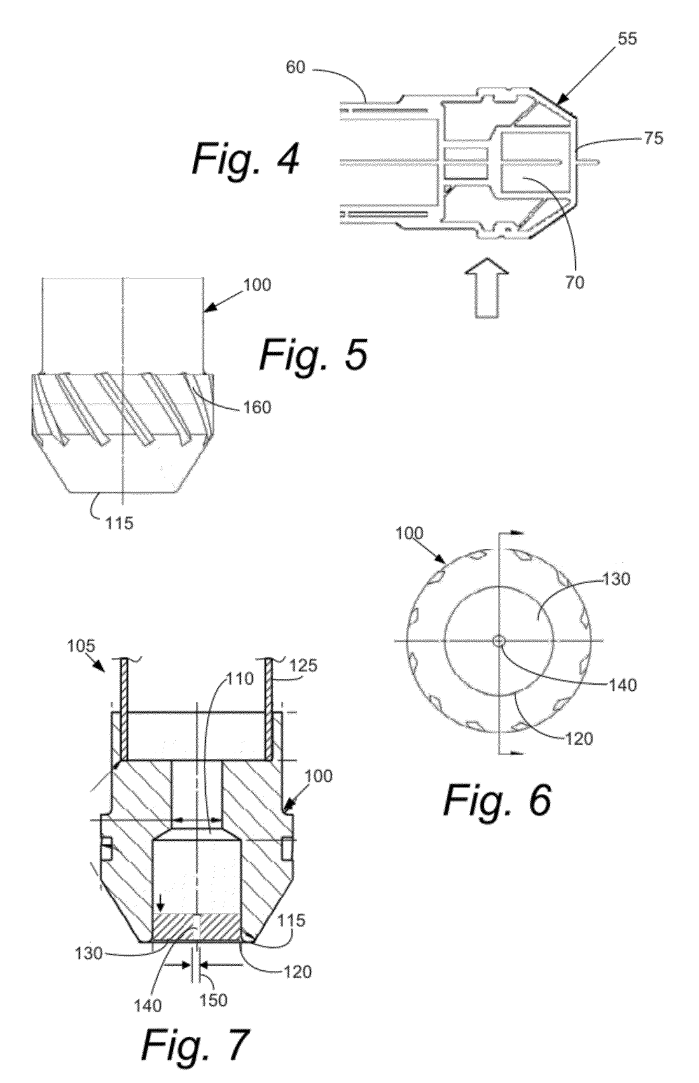

FIG. 2 shows a known fuel nozzle 50. The fuel nozzle 50 may be part of the combustor 25 as described above. By way of example, the combustor 25 may be a Dry Low NOₓ (DLN) combustor offered by General Electric Company of Schenectady, N.Y. The fuel nozzle 50 may have a gas only insert tip 55 positioned therein. The gas only insert tip 55 and an associated tube 60 are shown more clearly in FIGS. 3 and 4. The gas only insert tip 55 may include a number of vanes 65 on an exterior thereof. A pathway 70 extends from the tube 60 to a tip aperture 75. Hot gas ingestion through the gas only insert tip 55 may cause overheating of the tip 55 and bulging and other types of deformation within the tube 60. The hot gas ingestion may be caused by a vortex formed about the tip aperture 75. Gas leakage may also exist in a diffusion mode. Further, the gas only insert tip 55 may be made from a cobalt-based super alloy such as an HS-188 material and the like. This material may be acting as a catalyst so as to lower the activation energy required for a reaction. Other causes and combinations thereof may have an impact herein.

FIGS. 5-7 show a gas only insert tip 100 of a fuel nozzle 105 as may be described herein. The gas only insert tip 100 may be similar to the gas only insert tip 55 described above and may have a pathway 110 leading to a tip end 115 with a tip aperture 120 therein. Likewise, the gas only insert tip 100 may be positioned on an associated tube 125. In this example, a metal plug 130 may be positioned within the tip aperture 120. The plug 130 may be substantially flush with the face of the gas only insert tip 100. The plug 130 may be brazed or otherwise fixedly attached within the tip aperture 120. The plug 130 may be made out of a wrought nickel-based alloy such as a HST-X material or other types of substantially heat resistant materials. The plug 130 may have a thickness of about 0.125 inches (about 3.175 millimeters) in a tip aperture 120 having a diameter of about 0.25 inches (about 6.35 millimeters). Other shapes, configurations, and materials may be used herein.

The plug 130 may include a small diameter breather hole 140 in the middle thereof. The breather hole 140 may have any shape, length, or configuration. The breather hole 140 of the plug 130 may have a diameter 150 that may be sized to allow the internal volume of the gas only insert tip 100 and the associated tube 125 to breathe while preventing hot gas ingestion back therethrough. Specifically, the breather hole 14 may have the diameter 150 of about 0.06 (about 1.524 millimeters) inches or so in this example. Given the tip aperture 120 diameter of about 0.25 inches (about 6.35 millimeters), the breather hole 140 may reduce the size of the tip aperture 120 by about four (4) to one(1). Other sizes and ratios may be used herein. The breather hole 125 may be effective in any fuel mode and/or fuel transfers and the like.

The gas only insert tip 100 may have about the same tip mass as the tip 55 described above so as to avoid changes in the natural mechanical frequencies therein. A number of vanes 160 also may be used herein. The gas only insert tip 100 thus may have no negative impact on overall function or combustion dynamics. The plug 130 may be made out of the wrought nickel-based alloy materials and the like so as to reduce catalyst concerns.

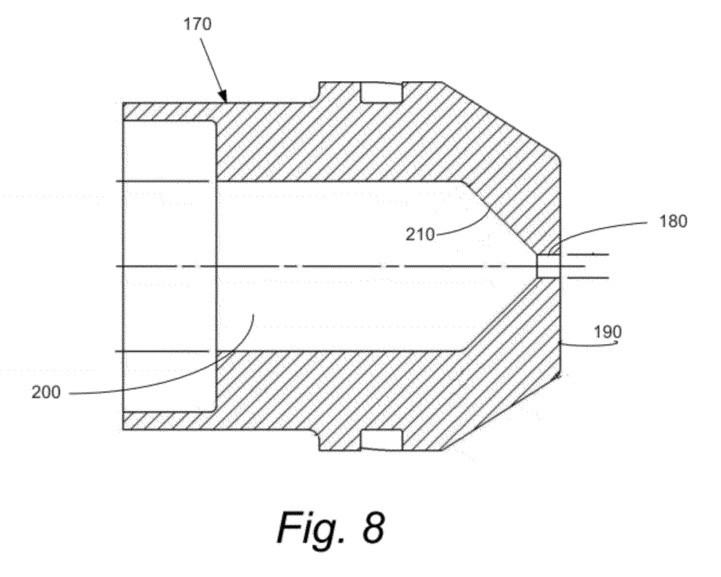

The plug 130 may be used as a retro-fit into the existing tip 55. In original equipment, the breather hole 140 may be positioned within the tip end 115 itself or other type of structure. FIG. 8 thus shows a unitary gas only insert tip 170. A breather hole 180 is formed therein at a tip end 190 thereon instead of the tip aperture 120 with the plug 130 described above. A pathway 200 leading thereto thus may have a substantially conical shape 210. Other configurations may be used herein with the diameter 150 as may be described above.

The gas only insert tip 100 with the plug 130 therein and/or the unitary gas only tip 170 thus reduces the internal temperatures within the tip 100 and the tube 125 and also reduces and/or eliminates bulging or other types of deformation within the tube 60 in any fuel mode. The gas only insert tips 100, 170 described herein provide these benefits without negatively impacting on overall system performance.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A fuel nozzle, comprising:
a tube;
a gas only insert tip positioned on the tube;
the gas only insert tip comprising a tip aperture; and
a plug positioned within the tip aperture.

2. The fuel nozzle of claim 1, wherein the plug comprises a breather hole therein.

3. The fuel nozzle of claim 2, wherein the breather hole comprises a diameter sufficiently large to allow an internal volume within the tube to breath without allowing hot gas ingestion therethrough.

4. The fuel nozzle of claim 1, wherein the plug comprises a wrought nickel based alloy.

5. The fuel nozzle of claim 1, wherein the plug is brazed within the tip aperture.

6. The fuel nozzle of claim 1, wherein the plug is flush with the tip aperture.

7. The fuel nozzle of claim 1, wherein the gas only insert tip comprises a pathway between the tube and the tip aperture.

8. The fuel nozzle of claim 1, wherein the gas only insert tip comprises a plurality of vanes positioned thereon.

9. A gas only insert for use with a fuel nozzle, comprising:
a tube;
a tip positioned on the tube;
the tip comprising a tip end; and
a breather hole positioned with the tip end;
wherein the breather hole comprises a diameter sufficiently large to allow an internal volume within the tube to breath without allowing hot gas ingestion therethrough.

10. The gas only insert of claim 9, wherein the tip end comprises a tip aperture therein and further comprising a plug positioned within the tip aperture such that the breather hole is positioned within the plug.

11. The gas only insert of claim 10, wherein the plug comprises a wrought nickel based alloy.

12. The gas only insert claim 10, wherein the plug is brazed within the tip aperture.

13. The gas only insert of claim 10, wherein the plug is flush with the tip aperture.

14. The gas only insert of claim 9, wherein the tip comprises a pathway between the tube and the tip end.

15. A combustor, comprising:
a plurality of fuel nozzles;
one or more of the plurality of fuel nozzles comprising a tube and a gas only insert tip; and
the gas only insert tip comprising a tip end with a breather hole therein.

16. The combustor of claim 15, wherein the breather hole comprises a diameter sufficiently large to allow an internal volume within the tube to breath without allowing hot gas ingestion therethrough.

17. The combustor of claim 15, wherein the tip end comprises a tip aperture therein and further comprising a plug positioned within the tip aperture such that the breather hole is positioned within the plug.

18. The combustor of claim 17, wherein the plug comprises a wrought nickel based alloy.

19. The combustor of claim 17, wherein the plug is brazed and flush within the tip aperture.

20. The gas only insert of claim 15, wherein the gas only insert tip comprises a pathway between the tube and the tip end.
